(19) United States
(12) Patent Application Publication
(10) Pub. No.: US 2012/0311599 A1
(43) Pub. Date: Dec. 6, 2012

(54) INFORMATION PROCESSOR AND INFORMATION PROCESSING METHOD

(76) Inventor: KOSUKE HARUKI, TACHIKAWA-SHI (JP)

(21) Appl. No.: 13/333,787

(22) Filed: Dec. 21, 2011

(30) Foreign Application Priority Data
May 31, 2011 (JP) 2011-122686

(51) Int. Cl. G06F 9/50

(52) U.S. Cl. 718/104

(57) ABSTRACT

According to one embodiment, an information processor includes processors of a plurality of types and a processing assignment module. The processing assignment module sequentially assigns basic modules to the processors if the processors are available based on the types of the processors. The type of a processor to which processing of each of the basic modules is preferentially assigned is specified in advance.

### CROSS-REFERENCE TO RELATED APPLICATIONS

This application is based upon and claims the benefit of priority from Japanese Patent Application No. 2011-122686, filed on May 31, 2011, the entire contents of which are incorporated herein by reference.

### FIELD

Embodiments described herein relate generally to an information processor and an information processing method.

### BACKGROUND

Conventional multi-thread parallel programming generates multiple threads and performs synchronization process so that the generated threads are executed in the proper order. This maintains thread-level parallelism while keeping data dependence. In this case, however, the synchronization process needs to be located at several places in the program, which constitutes a factor of increasing costs for maintenance and program debug.

Besides, the programming takes into account the subject of each thread, such as process to be performed by the thread and part of data which the thread is in charge of. Accordingly, if the number of processors increases like from two to four, eight, . . . , to exploit sufficient parallelism, it is required to review the structure of the program or to redesign the parallel control.

By executing a thread in response to a process request (work item), it is possible, to a certain extent, to separate the scalability for the number of processors, parallel execution instructions, and synchronization part. According to this method, a necessary number of threads are generated and pooled, and the threads sequentially take out work items from a request queue and execute them. In this method, a request is generated with a high degree of freedom and thus is complicated, which makes it difficult to debug. Further, the order of processes depends on implementation of a FIFO queue, and therefore sufficient parallelism cannot be achieved. In the process of each work item, the synchronization process and exclusion process are not prevented from being performed.

The conventional multi-thread parallel programming is forced to generate multiple threads each taking into account the synchronization process. For example, to keep the execution order proper, process ensuring synchronization needs to be located at various places in the program, which makes it difficult to debug the program, resulting in the increase of maintenance costs.

There has been disclosed a conventional technology for realizing parallel processing, upon generation of multiple threads, based on the dependence between the threads and execution results thereof. With the conventional technology, it is required to quantitatively specify in advance a thread to be executed redundantly. Due to this, the program change is less flexible.

To execute programs in parallel while the execution order is kept proper between the programs, it is required to fixedly determine in advance dependence between the programs or threads.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a configuration of an information processor according to a first embodiment;

FIG. 2 is an exemplary functional block diagram of the information processor in the first embodiment;

FIG. 3 is an exemplary schematic diagram for explaining dependence between basic modules in the first embodiment;

FIG. 4 is an exemplary schematic diagram for explaining a node in the first embodiment;

FIG. 5 is an exemplary schematic diagram for explaining the queuing of nodes in an executable queue in the first embodiment;

FIG. 6 is an exemplary diagram of a byte code description (graph-data structuring description) of a node in the first embodiment;

FIG. 7 is an exemplary diagram of a parallel execution control description in the first embodiment;

FIG. 8 is an exemplary diagram for explaining a motion vector in a current frame in the first embodiment;

FIG. 9 is an exemplary diagram for explaining a motion vector in a previous frame in the first embodiment;

FIG. 10 is an exemplary schematic diagram of a configuration of an information processor according to a second embodiment;

FIG. 11 is an exemplary conceptual diagram of queues of execution devices in the second embodiment;

FIG. 12 is an exemplary diagram for explaining the operation of the second embodiment; and

FIG. 13 is an exemplary flowchart of the operation of the second embodiment.

### DETAILED DESCRIPTION

In general, according to one embodiment, an information processor comprises processors of a plurality of types and a processing assignment module. The processing assignment module is configured to sequentially assign basic modules to the processors if the processors are available based on the types of the processors. The type of a processor to which processing of each of the basic modules is preferentially assigned is specified in advance.

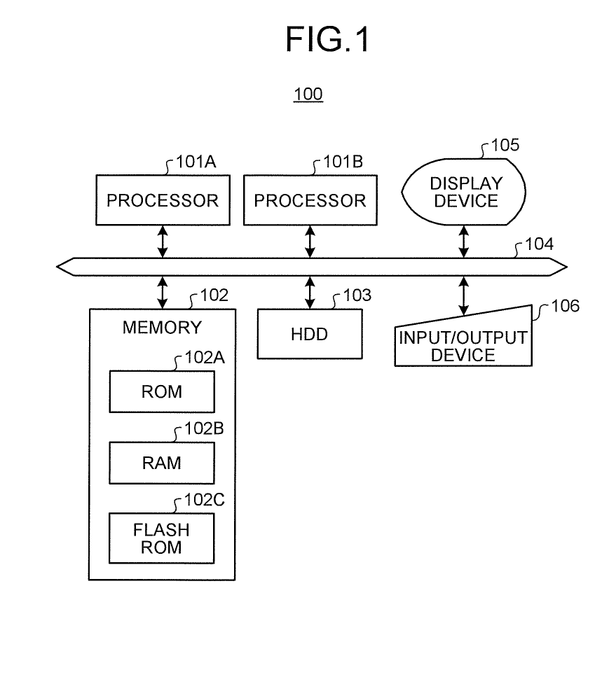

FIG. 1 schematically illustrates an example of a configuration of an information processor 100 according to a first embodiment. As illustrated in FIG. 1, the information processor 100 comprises a plurality of processors 101A and 101B, a memory 102, a hard disk drive (HDD) 103, an internal bus 104, a display device 105, and an input/output device 106. The processors 101A and 101B are categorized into a plurality of types. The memory 102 stores various types of data. The HDD 103 functions as an external storage device. Various types of data are transferred between the modules via the internal bus 104. The display device 105 displays various types of information. The input/output device 106 includes, for example, a keyboard to input various types of data. The information processor 100 may have a configuration without the display device 105 and the input/output device 106.

The processor 101A is a general-purpose processor capable of performing complicated processing at a high speed using relatively high branch prediction and a multifunctional calculator. The processor 101A may be, for example, a central processing unit (CPU). Meanwhile, the processor 101B is a processor capable of performing relatively simple operation (for example, matrix operation, etc.) at a high speed for a large amount of data. Examples of the processor 101B include graphics processing unit (GPU) and digital signal processor (DSP).

The memory 102 comprises a read-only memory (ROM) 102A, a random-access memory (RAM) 102B, and a flash ROM 102c. The ROM 102A stores various types of data in a nonvolatile manner. The RAM 102B temporarily stores various types of data and provides a work area. The flash ROM 102c updatably stores various types of data in a nonvolatile manner.

The HDD 103 is configured to store a relatively large amount of data. Accordingly, program codes to be executed by the processors 101A and 101B are stored in the HDD 103, and only part of them is loaded into the memory 102 (especially, the RAM 102B) and executed.

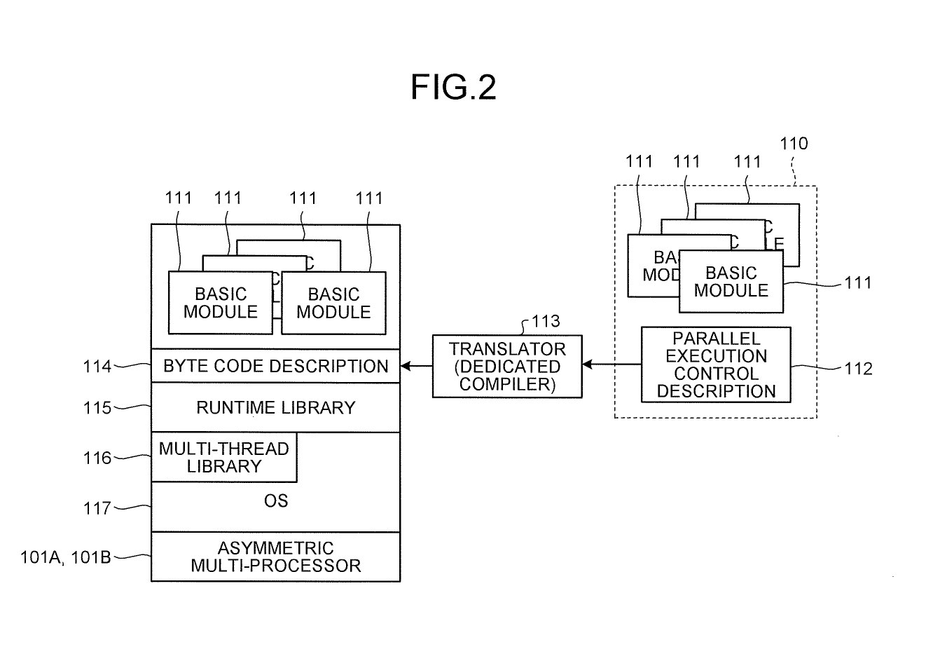

FIG. 2 is a functional block diagram of the first embodiment. Basically, a parallel program 110 executed by the information processor 100 includes basic modules 111 and a parallel execution control description 112. The basic modules 111 are modularized programs executed by the information processor 100. The parallel execution control description 112 is data that is referred to upon execution of the basic modules 111. More specifically, with respect to each of the basic modules 111, the parallel execution control description 112 describes dependence in parallel processing. Before the execution by the information processor 100, the parallel execution control description 112 is compiled by a translator 113 to a byte code description 114 independent of a platform.

Accordingly, the byte code description 114 indicates dependence between the basic modules 111. More specifically, with respect to one of the basic modules 111 to be executed (hereinafter, for the sake of convenience, the basic module in question will be referred to as “basic module 111X”), the byte code description 114 describes dependence between the basic module 111X and one or more basic modules 111 that are previously executed to output execution result(s) necessary to execute the basic module 111X and between the basic module 111X and one or more subsequent basic modules 111 that use the execution result of the basic module 111X.

Software executed on the asymmetric multi-processors of the information processor 100 comprises the basic modules 111, the byte code description 114, a runtime library 115, a multi-thread library 116, and an operating system (OS) 117. The runtime library 115 includes an application programming interface (API) to execute the basic modules 111 on the information processor 100 and the like. The runtime library 115 implements exclusion control necessary for parallel processing of the basic modules 111.

The multi-thread library 116 is a runtime library used to execute the basic modules 111 by multiple threads. The multi-thread library 116 implements exclusion control necessary for processing of the basic modules 111 by multiple threads.

The runtime library 115 or the multi-thread library 116 may be configured to call the function of the translator 113 so that, each time called in the process of execution of the basic module 111, the translator 113 converts part of the parallel execution control description 112 for the next processing. With this, there is no need of a resident task for translation, and more compact parallel processing can be realized.

The OS 117 manages the whole system such as the hardware of the information processor 100 and the scheduling of tasks. With the OS 117, upon execution of the basic modules 111, the programmer can dispense with various system management tasks and concentrate on programming and also easily describe software that is generally operable on various models.

The information processor 100 of the first embodiment divides a program at parts where synchronization process and data exchange are required, and defines the relationship between the parts as a parallel execution control description. With this, the basic modules 111 can be repeatedly used as parts during execution of a parallel program, and the parallel execution control description 112 can be managed to be compact.

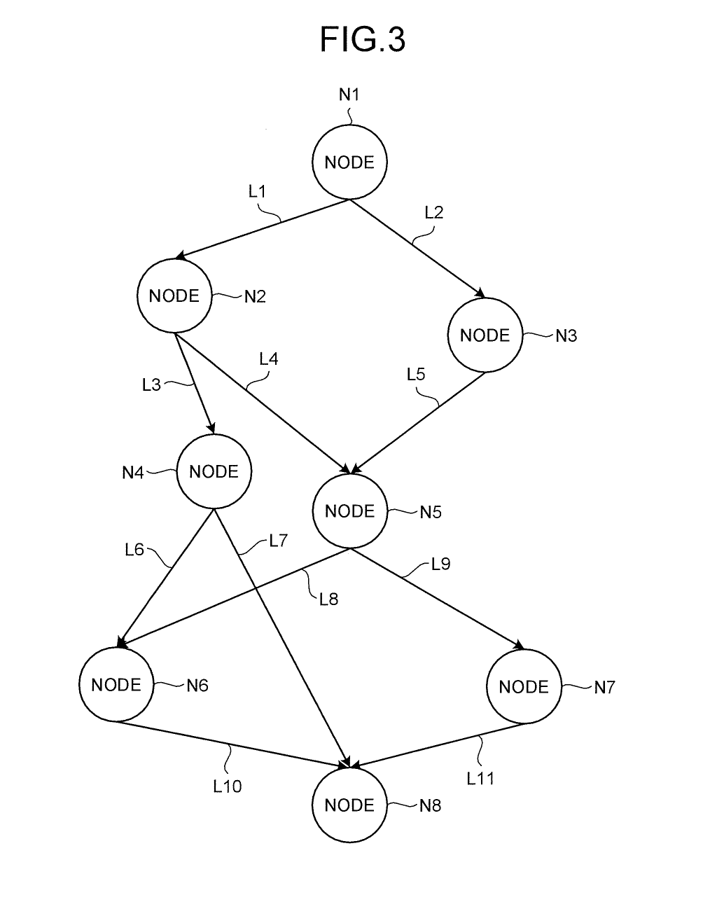

FIG. 3 is a schematic diagram for explaining an example of dependence between basic modules according to the first embodiment. In FIG. 3, the basic modules 111 that performs a series of processes are represented as nodes N1 to N8. Once process start conditions are satisfied, each of the nodes N1 to N8 can proceed processing regardless of the operation state of basic modules corresponding to other nodes. In the example of FIG. 3, the nodes N1 to N8 performs processing in one direction from the top to the bottom.

Links L1 to L11 connecting between the nodes N1 to N8 each represent dependence between one node and another node. With respect to the node having the link on the input side (in FIG. 5, upper side), for example, the node N3, its process start conditions are not satisfied until the node N1 on the input side completes processing, and thus the node N3 cannot proceed processing. Similarly, with respect to the node N5 connected to the nodes N2 and N3 on the input side via the links L4 and L5, respectively, its process start conditions are not satisfied until both the nodes N2 and N3 corresponding to the links L4 and L5 complete processing, and thus the node N5 is in standby mode.

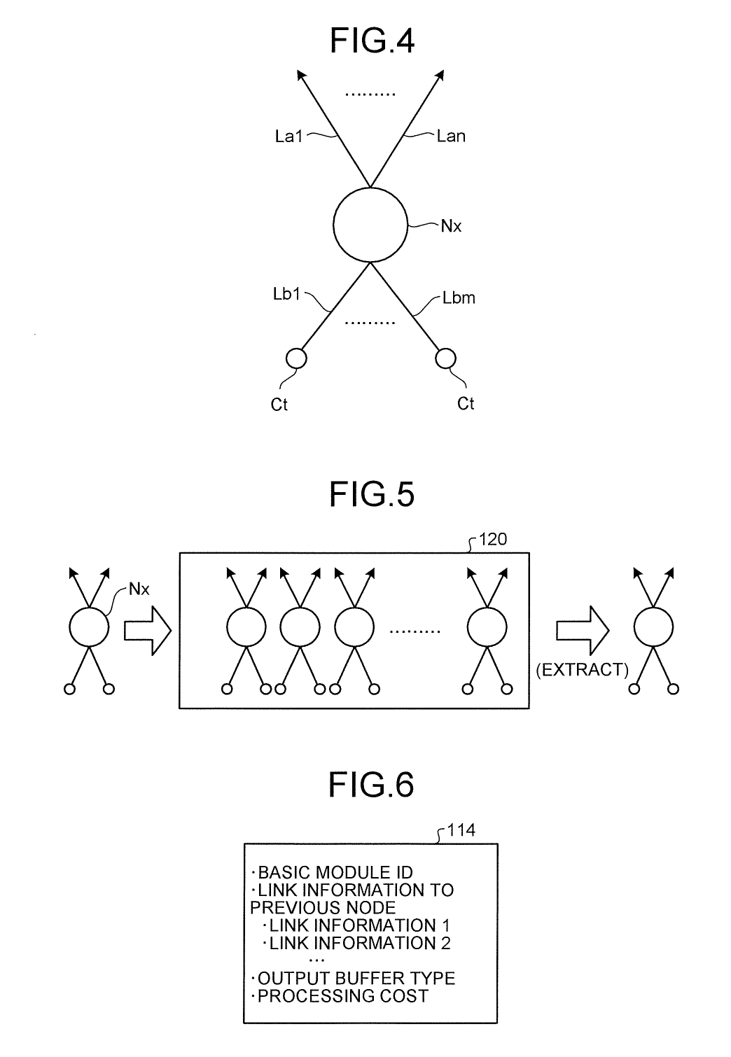

FIG. 4 is a schematic diagram for explaining an example of a node of the first embodiment. As described above, the node Nx (in the first embodiment, x: a number 1 to 8) corresponds to each of the basic modules 111. After the translator 113 converts the parallel execution control description 112 to the byte code description 114, the basic modules 111 are graph-data structured into the nodes based on the byte code description 114.

As described above, the node Nx obtained by graph-data structuring the basic module 111 has dependence with another node by the link Ly (in the first embodiment, y: a number 1 to 11). As illustrated in FIG. 4, regarding the basic module 111 as the node Nx, there are two types of links as the link Ly, i.e., n links La1 to Lan connected to previous nodes and m links Lb1 to Lbm each having a connector ct to a subsequent node.

The links La1 to Lan are each connected to the output terminal of another node to obtain data necessary for the node Nx to perform predetermined processing. Each of the links La1 to Lan has information that defines a necessary link to a node and the type of the output terminal of the node.

The connector ct of the links Lb1 to Lbm is provided with identification information indicating what data is to be output after the processing of the node Nx. The subsequent nodes can determine whether their conditions to be executed are satisfied based on the identification information of the connector ct of the links Lb1 to Lbm and the parallel execution control description 112.

FIG. 5 is a schematic diagram for explaining the queuing of nodes in an executable queue according to the first embodiment. When the system determines that the conditions to execute the node Nx are satisfied, as illustrated in FIG. 5, the node Nx is queued to an executable queue 120 on a node-by-node basis. A node to be executed next is taken out from those queued in the executable queue 120.

FIG. 6 illustrates an example of the byte code description 114 (graph-data structuring description) of a node of the first embodiment. FIG. 6 illustrates the byte code description 114 compiled by the translator 113 based on the parallel execution control description 112. The byte code description 114 contains information such as basic module ID, a plurality of pieces of link information to previous nodes, the type of the output buffer of the node, processing cost of the node, and the like. The term “processing cost” as used herein refers to processing time required to process the basic module 111 corresponding to the node and the like. The information on processing cost is considered upon selecting a node to be extracted next from those queued in the executable queue.

The link information to a previous node Nb defines conditions of a node to be the previous node Nb for the node Nx. For example, the link information may define the previous node Nb as a node that outputs data of a predetermined type or a node having a specific ID.

The byte code description 114 describes the corresponding basic module 111 as anode and provides information used to add the basic module 111 to an existing graph-data structure as illustrated in FIG. 6 based on the link information.

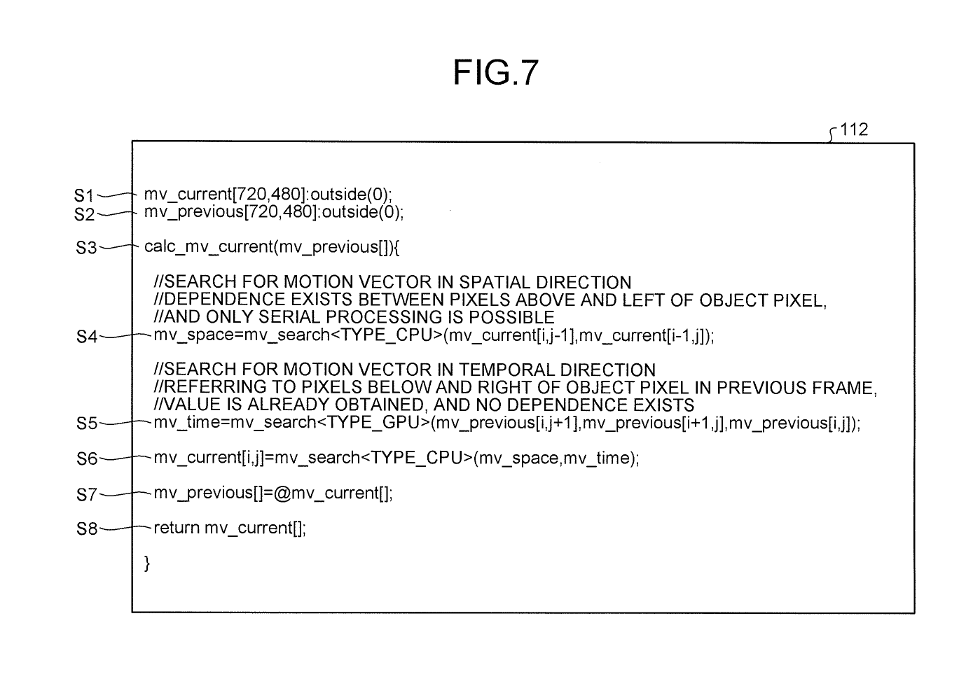

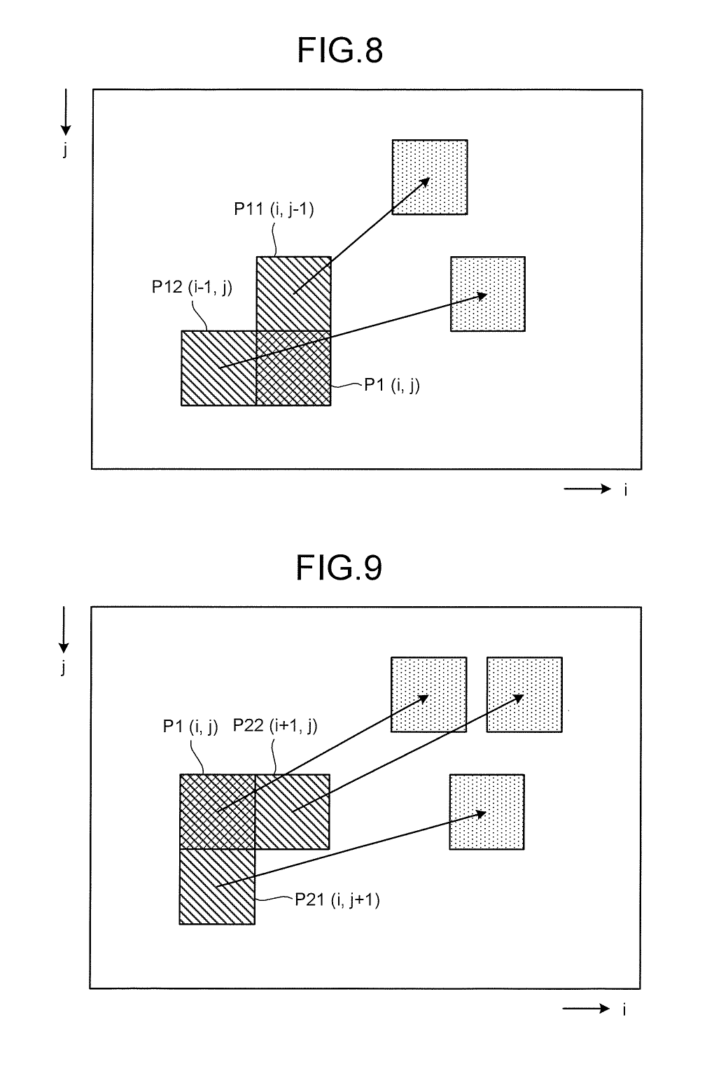

In the following, the operation of the first embodiment will be described. FIG. 7 illustrates an example of the parallel execution control description 112 of the first embodiment. FIG. 8 is a diagram for explaining a motion vector in a current frame. FIG. 9 is a diagram for explaining a motion vector in a previous frame.

As illustrated in FIG. 7, first, a sequence region is secured for data processing (S1, S2). In the example of FIG. 7, the display screen has a resolution of 720×480 pixels, and two sequence regions, i.e., sequence mv_previous to store pixel data of the previous frame and sequence mv_current to store pixel data of the current frame, are secured (each for 720×480 pixels).

Next, the motion vector of an object pixel is calculated based on pixel data stored in these sequence regions (S3). First, a motion vector is searched for in the spatial direction (S4). More specifically, with respect to motion vector mv_space in the spatial direction, using motion vector mv_current [i, j−1] of a pixel P11 in the coordinates (i, j−1) adjacent to the top of the object pixel P1 in the coordinates (i, j) in the current frame and motion vector mv_current [i−1, j] of a pixel P12 in the coordinates (i−1, j) adjacent to the left of the object pixel P1 in the coordinates (i, j) in the current frame as parameters, search function mv_search at the search center point is obtained.

In this case, between the pixels adjacent to the object pixel (in the first embodiment, the pixel P11 above the object pixel P1 and the pixel P12 on the left), dependence exists in processing in the same frame, which allows only serial processing. Because of accompanying various conditional branching operations, the general-purpose processor 101A is suitable for the calculation. Accordingly, the parallel execution control description 112 describes <TYPE_CPU> indicating that the processor 101A is used for the processing. As a result, the OS 117 preferentially assigns the processing to the general-purpose processor 101A.

Subsequently, a motion vector is searched for in the temporal direction (S4). More specifically, with respect to motion vector mv_time in the temporal direction, using motion vector mv_previous [i, j+1] of a pixel P21 in the coordinates (i, j+1) adjacent to the bottom of the object pixel P1 in the coordinates (i, j) in the previous frame and motion vector mv_previous [i+1, j] of a pixel P22 in the coordinates (i+1, j) adjacent to the right of the object pixel P1 in the coordinates (i, j) in the previous frame as parameters, search function mv_search at the search center point is obtained.

Then, using obtained motion vector mv_space in the spatial direction and motion vector mv_time in the temporal direction as parameters, search function mv_search at the search center point is obtained, and motion vector mv_current [i, j] of the object pixel in the current frame is calculated (S6).

In this case also, the calculation is likely to involve various conditional branching operations, and therefore the general-purpose processor 101A is suitable for the calculation. Accordingly, the parallel execution control description 112 describes <TYPE_CPU> indicating that the processor 101A is used for the processing. As a result, the OS 117 preferentially assigns the processing to the general-purpose processor 101A.

After that, calculated values of the motion vectors of all pixels of the current frame are stored as the motion vector of the previous frame (S7), and the processing ends (S8).

As described above, according to the first embodiment, it is possible to specify in advance a processor to actually perform processing in the parallel execution control description 112. That is, it is possible to specify a processor (device) to execute each of the basic modules 111. Thus, upon dynamically executing the basic modules 111 with a plurality of processors, parallel processing can be performed efficiently, and processing efficiency can be improved.

A second embodiment will be described. According to the second embodiment, execution characteristics of a task are specified, and the runtime determines the assignment of the task depending on the execution characteristics of processors (devices). In the following, a description will be given, by way of example, of an information processor comprising a plurality of CPUs, a plurality of GPUs, and a plurality of DSPs.

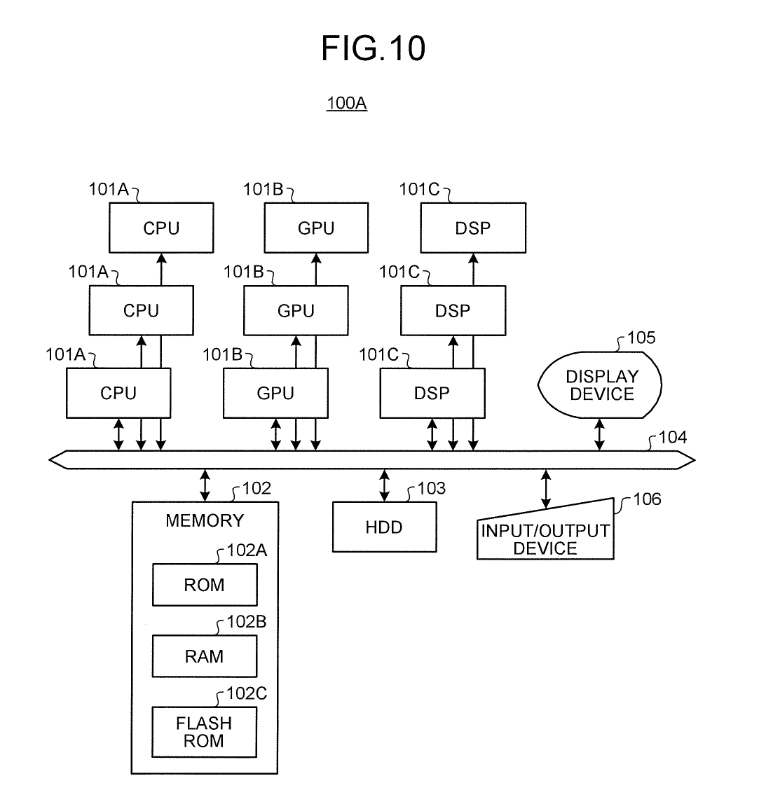

FIG. 10 schematically illustrates an example of a configuration of an information processor 100A according to the second embodiment. Like reference numerals refer to the same elements as illustrated in FIG. 1. As illustrated in FIG. 10, the information processor 100A comprises a plurality of CPUs 101A (in FIG. 10, three), a plurality of GPUs 101B (in FIG. 10, three), a plurality of DSPs 101C (in FIG. 10, three), the memory 102, the HDD 103, the internal bus 104, the display device 105, and the input/output device 106. The memory 102 stores various types of data. The HDD 103 functions as an external storage device. Various types of data are transferred between the modules via the internal bus 104. The display device 105 displays various types of information. The input/output device 106 includes, for example, a keyboard to input various types of data. The information processor 100A may have a configuration without the display device 105 and the input/output device 106. Generally, the CPUs 101A are suitable for calculation-based serial arithmetic, while the GPUs 101B and the DSPs 101C are suitable for parallel arithmetic.

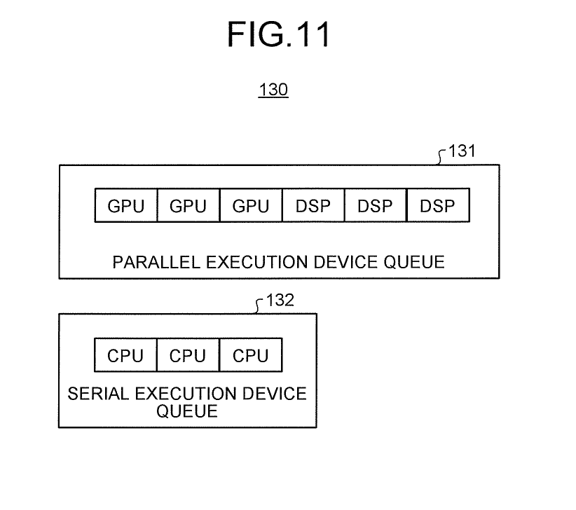

FIG. 11 is a conceptual diagram of a queue of execution devices. In the second embodiment, as illustrated in FIG. 11, upon assigning the processors 101A to 101C to execution device queues 130, the parallel execution devices GPUs 101B and DSPs 101C are assigned to a parallel execution device queue 131, while the CPUs 101A are assigned to a serial execution device queue 132.

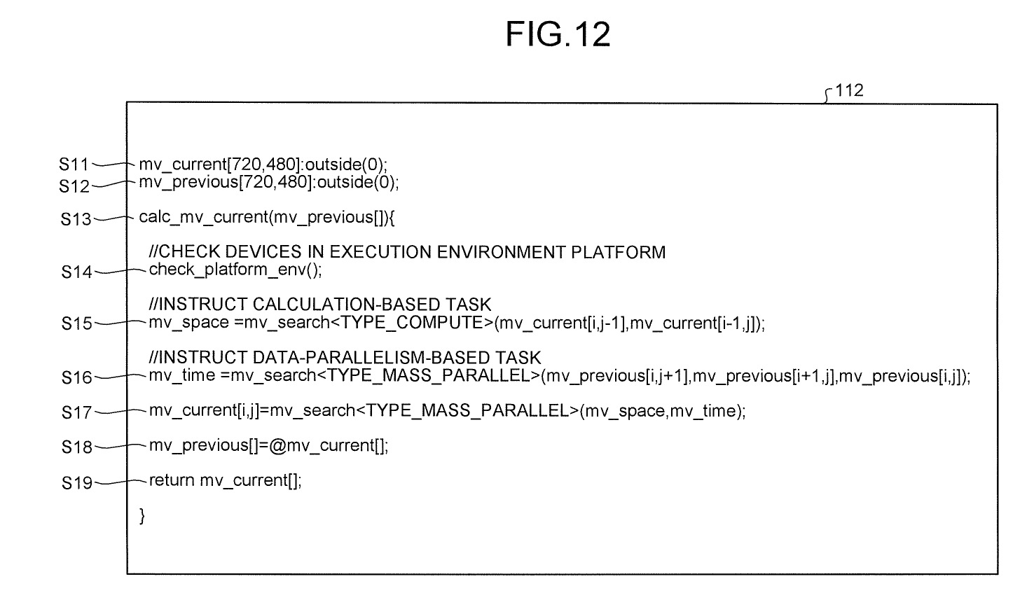

FIG. 12 is a diagram for explaining the operation of the second embodiment. This example illustrates a general procedure for obtaining the motion vector of the object pixel P1 from two video frames, i.e., previous and current frames, as in the first embodiment.

As illustrated in FIG. 12, first, a sequence region is secured for data processing (S11, S12). In the example of FIG. 12, the display screen has a resolution of 720×480 pixels, and two sequence regions, i.e., sequence mv_previous to store pixel data of the previous frame and sequence mv_current to store pixel data of the current frame, are secured (each for 720×480 pixels).

Next, the motion vector of an object, pixel is calculated based on pixel data stored in these sequence regions (S13). First, it is checked what kind of devices are present in an execution environment platform (S14). More specifically, the number and types of devices in the execution environment platform are detected by executing device detection function check_platform_env( ). For example, in the case of FIG. 10, it is detected that there are the three CPUs 101A, the three GPUs 101B, and the three DSPs 101C.

Next, a motion vector is searched for in the spatial direction (S15). As described above, with respect to motion vector mv_space in the spatial direction, between the pixels adjacent to the object pixel (in the second embodiment, pixels above and left of the object pixel), dependence exists in processing in the same frame. Accordingly, serial processing, i.e., calculation-based task, is instructed. More specifically, with respect to the calculation of motion vector mv_space in the spatial direction, the parallel execution control description 112 describes <TYPE_COMPUTE> instructing a calculation-based task. As a result, the OS assigns the processing to the CPU 101A (general-purpose processor) registered in the serial execution device queue 132.

Subsequently, a motion vector is searched for in the temporal direction (S16). As described above, motion vector mv_time in the temporal direction is calculated using data already obtained in the previous frame. Accordingly, data-parallelism-based task is instructed. More specifically, with respect to the calculation of motion vector mv_time in the temporal direction, the parallel execution control description 112 describes <TYPE_MASS_PARALLEL> instructing a data-parallelism-based task. As a result, the OS assigns the processing to the GPU 101B or the DSP 101C registered in the parallel execution device queue 131.

Then, using obtained motion vector mv_space in the spatial direction and motion vector mv_time in the temporal direction as parameters, search function mv_search at the search center point is obtained, and motion vector mv_current [i, j] of the object pixel in the current frame is calculated (S17).

For the calculation of motion vector mv_current [i, j] of the object pixel in the current frame, the parallel execution control description 112 also describes <TYPE_MASS_PARALLEL> instructing a data-parallelism-based task. As a result, the OS assigns the processing to the GPU 101B or the DSP 101C registered in the parallel execution device queue 131.

After that, calculated values of the motion vectors of all pixels of the current frame are stored as the motion vector of the previous frame (S18), and the processing ends (S19).

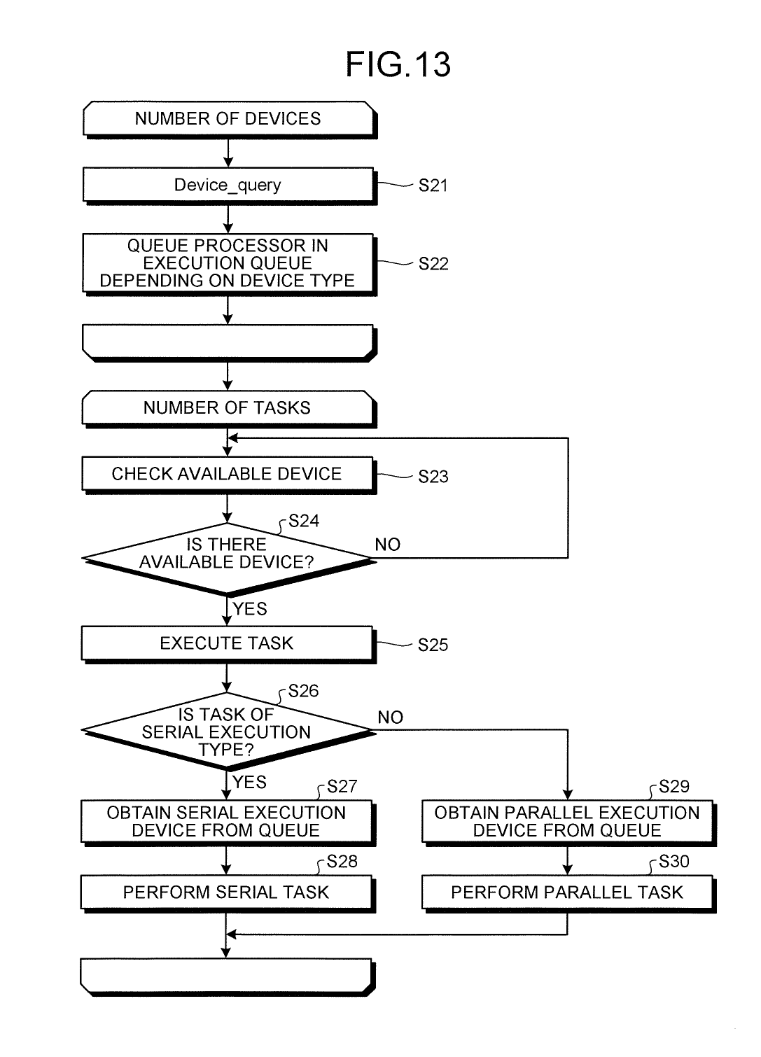

FIG. 13 is a flowchart of the operation of the second embodiment. First, a device query is issued a number of times corresponding to the number of processors (devices) in the platform (in the second embodiment, nine) to ask the type of each device (S21). Each processor is queued in the execution queue based on a response to the device query (S22). Then, an available device is checked a number of times corresponding to the number of tasks to be processed (S23) to determine whether there is an available device (S24).

If there is no available device (No at S24), the process is in standby. On the other hand, if there is an available device (Yes at S24), a corresponding task is executed (S25), and the type of the task is determined (S26).

If the task is a calculation-based task of serial execution type (Yes at S26), a serial execution device (in the second embodiment, the CPU 101A) is obtained form the serial execution device queue 132 (S27) so that the serial execution device performs the task (S28).

On the other hand, if the task is of parallel execution type (No at S26), a parallel execution device (in the second embodiment, the GPU 101B or the DSP 101C) is obtained form the parallel execution device queue 131 (S29) so that the parallel execution device performs the task (S30). The process from the S21 to S30 is repeated until all the tasks are completed.

As described above, according to the second embodiment, the number and types of devices in the execution environment platform are detected. With this, processing is assigned to a device of a type specified in advance in the parallel execution control description. Thus, effective processing efficiency can be improved, which contributes to a reduction in processing costs.

The control program executed on the information processor of the embodiments may be provided as being stored in a computer-readable storage medium, such as a compact disc-read only memory (CD-ROM), a flexible disk (FD), a compact disc recordable (CD-R), and a digital versatile disc (DVD), as a file in an installable or executable format.

The control program may also be stored in a computer connected via a network such as the Internet so that it can be downloaded therefrom via the network. Further, the control program may be provided or distributed via a network such as the Internet. The control program may also be provided as being stored in advance in a ROM or the like.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
processors of a plurality of types; and
a processing assignment module configured to sequentially assign basic modules to the processors based on the types of the processors, wherein a type of a processor to which processing of each of the basic modules is preferentially assigned is specified in advance.

2. The information processor of claim 1, wherein the processing assignment module is configured to sequentially assign the basic modules to the processors based further on parallel processing relationship between the basic modules.

3. The information processor of claim 2, wherein the processing assignment module is configured to be provided with parallel execution control information set in advance, the parallel execution control information indicating the parallel processing relationship between the basic modules and the type of a processor to which processing of each of the basic modules is preferentially assigned.

4. The information processor of claim 1, wherein, if there are a plurality of processors of the same type, the processing assignment module assigns a new basic module to one of the processors that is not processing a basic module.

5. The information processor of claim 1, wherein, if all processors of a type to which a basic module is specified to be assigned are performing processing, the processing assignment module assigns the basic module to a processor of another type to which no basic module is assigned.

6. The information processor of claim 5, wherein if determining that total processing cost is lower when the basic module is assigned to the processor of the other type than when not, the processing assignment module assigns the basic module to the processor of the other type.

7. The information processor of claim 1, wherein each of the basic modules can be executed at a point when input data is determined.

8. An information processing method applied to an information processor comprising processors of a plurality of types, the information processing method comprising:
obtaining parallel execution control information in which a type of a processor to which processing of each of basic modules is preferentially assigned is specified in advance; and
sequentially assigning the basic modules to the processors based on the parallel execution control information.

9. A non-transitory computer readable storage medium having stored thereon instructions that, when executed by a computer, cause the computer to control an information processor comprising processors of a plurality of types and to:
obtain parallel execution control information in which a type of a processor to which processing of each of basic modules is preferentially assigned is specified in advance; and
sequentially assign the basic modules to the processors based on the parallel execution control information.
